(19) United States
(12) Patent Application Publication
(10) Pub. No.: US 2025/0264979 A1
(43) Pub. Date: Aug. 21, 2025

(54) MULTIMEDIA CONTENT ITEM POSTING METHOD, RELATED DEVICE, AND COMPUTER-READABLE STORAGE MEDIUM

(71) Applicant: Beijing Zitiao Network Technology Co., Ltd., Beijing (CN)

(72) Inventor: Xiaotong MA, Beijing (CN)

(21) Appl. No.: 19/058,493

(22) Filed: Feb. 20, 2025

(30) Foreign Application Priority Data
Feb. 20, 2024 (CN) 202410190236.X

(51) Int. Cl. G06F 3/0484; G06F 9/451

(52) U.S. Cl. CPC G06F 3/0484; G06F 9/451

(57) ABSTRACT

The present disclosure relates to a multimedia content item posting method, a related device, and a computer-readable storage medium, and relates to the field of multimedia technologies. The multimedia content item posting method includes: displaying, during a process of posting first multimedia content item and second multimedia content item on an application, a first control on a desktop in response to the application being switched to the background with the desktop displayed; displaying posting progress information of the first multimedia content item in the first control; and displaying posting progress information of the second multimedia content item in the first control in response to the posting progress information of the first multimedia content item meeting a specified condition.

### CROSS-REFERENCE TO RELATED APPLICATIONS

The present disclosure is based on and claims the priority of Chinese Patent Application No. 202410190236.X, filed on Feb. 20, 2024, the disclosure of which is hereby incorporated into this disclosure by reference in its entirety.

### TECHNICAL FIELD

The present disclosure relates to the field of multimedia technologies, and in particular, to a multimedia content item posting method, a related device, and a computer-readable storage medium.

### BACKGROUND

In some applications, a user may edit multimedia resources such as images, sounds, videos, and special effects to create new multimedia content item and post the multimedia content item, or may directly post existing multimedia content item. Then, the multimedia content item posted by the user can be view on a network.

### SUMMARY

This Summary of the Invention section is provided to give a brief overview of concepts, and these concepts are described in detail later in the Detailed Description of Embodiments section. The Summary of the Invention section is neither intended to identify key features or necessary features of the claimed technical solutions, nor is it intended to be used to limit the scope of the claimed technical solutions.

According to some embodiments of the present disclosure, a multimedia content item posting method is provided, including: displaying, during a process of posting first multimedia content item and second multimedia content item on an application, a first control on a desktop in response to the application being switched to the background with the desktop displayed; displaying posting progress information of the first multimedia content item in the first control; and displaying posting progress information of the second multimedia content item in the first control in response to the posting progress information of the first multimedia content item meeting a specified condition.

According to some embodiments of the present disclosure, an electronic device is provided, including: a memory; and a processor coupled to the memory, where the processor is configured to perform the multimedia content item posting method according to any one of the embodiments of the present disclosure based on instructions stored in the memory.

According to some embodiments of the present disclosure, there is provided a computer-readable storage medium having a computer program stored thereon, where the program, when executed by a processor, causes the multimedia content item posting method according to any one of the embodiments of the present disclosure to the implemented.

According to some embodiments of the present disclosure, there is provided a computer program product. The computer program product, when running on a computer, causes the computer to implement the multimedia content item posting method according to any one of the embodiments of the present disclosure.

Through the following detailed description of exemplary embodiments of the present disclosure with reference to accompanying drawings, other features, aspects, and advantages of the present disclosure will become clear.

### BRIEF DESCRIPTION OF THE DRAWINGS

Preferred embodiments of the present disclosure are described below with reference to the accompanying drawings. The accompanying drawings illustrated herein are used to provide a further understanding of the present disclosure, and together with the following detailed description, are incorporated in and form a part of the specification, to explain the present disclosure. It should be understood that the accompanying drawings in the following description relate to only some embodiments of the present disclosure, and do not constitute a limitation on the present disclosure. In the accompanying drawings:

FIG. 1 is a schematic flowchart of a multimedia content item posting method according to some embodiments of the present disclosure.

FIG. 2A to FIG. 2F are schematic diagrams of a first control according to some embodiments of the present disclosure.

FIG. 3 is a schematic diagram of a playback interface for multimedia content item according to some embodiments of the present disclosure.

FIG. 4 is a schematic diagram of a structure of a multimedia content item posting apparatus according to some embodiments of the present disclosure.

FIG. 5 is a schematic diagram of a structure of an electronic device according to some embodiments of the present disclosure.

FIG. 6 is a schematic diagram of a structure of a computer system according to some embodiments of the present disclosure.

It should be understood that, for ease of description, the sizes of various parts shown in the accompanying drawings are not necessarily drawn to actual scale. The same or similar reference signs in the accompanying drawings are used to denote the same or similar components. Therefore, once an item is defined in one of the drawings, it may not be further discussed in the subsequent accompanying drawings.

### DETAILED DESCRIPTION

The technical solutions in the embodiments of the present disclosure are clearly and completely described below with reference to the accompanying drawings of the embodiments of the present disclosure. However, apparently, the embodiments described are merely some embodiments of the present disclosure rather than all the embodiments. The following description of the embodiments is actually merely illustrative, and in no way serves as any limitation to the present disclosure and application or use thereof. It should be understood that the present disclosure may be implemented in various forms and should not be construed as being limited to the embodiments set forth herein.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect. Unless specifically stated otherwise, the relative arrangement of components and steps, numerical expressions, and numerical values set forth in these embodiments should be construed as merely exemplary, and do not limit the scope of the present disclosure.

The term “include” and the variations thereof used in the present disclosure are open-ended terms that include at least subsequent elements/features but do not exclude other elements/features, that is, “including but not limited to”. In addition, the term “comprise” and the variations thereof used in the present disclosure are open-ended terms that comprise at least subsequent elements/features but do not exclude other elements/features, that is, “comprising but not limited to”. Thus, “include” is synonymous with “comprise”. The term “based on” means “at least partially based on”.

The terms “one embodiment”, “some embodiments”, or “an embodiment” described throughout the specification means that the specific features, structures, or characteristics described in connection with the embodiments are included in at least one embodiment of the present invention. For example, the term “one embodiment” means “at least one embodiment”. The term “another embodiment” means “at least one another embodiment”. The term “some embodiments” means “at least some embodiments”. Moreover, the phrases “in one embodiment”, “in some embodiments”, or “in an embodiment” appearing in various places throughout the specification do not necessarily all refer to the same embodiment, but may also refer to the same embodiment.

It should be noted that concepts such as “first” and “second” mentioned in the present disclosure are only used to distinguish between different apparatuses, modules, or units, and are not used to limit the sequence of functions performed by these apparatuses, modules, or units or interdependence. Unless otherwise specified, concepts such as “first” and “second” are not intended to imply that the objects described in this way must be in a given order in terms of time, space, or ranking, or in any other given order.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

The embodiments of the present disclosure are described in detail below with reference to the accompanying drawings. However, the present disclosure is not limited to these specific embodiments. The following specific embodiments may be combined with each other, and the same or similar concepts or processes may not be repeated in some embodiments. Furthermore, in one or more embodiments, specific features, structures, or characteristics may be combined in any suitable manner that would be clear to those of ordinary skill in the art from the present disclosure.

A multimedia content item posting process is a process from a user requesting to post multimedia content item (for example, by triggering the posting of the multimedia content item) to the posting of the multimedia content item being completed. The posting process may include a plurality of stages, for example, one or more posting stages such as requesting parameters, synthesizing multimedia resources, uploading multimedia content item, uploading additional information (for example, special effects and subtitles) of the multimedia content item, creating the multimedia content item, and completing the posting. Therefore, a posting process of each piece of multimedia content item needs to consume a specific time, and the time is affected by a size and complexity of multimedia resources, network conditions, and the like.

An operating system of a terminal allows part or all of the multimedia content item posting process to run in the background. Table 1 illustrates, by way of example, whether iOS and Android support background processing of the stages.

TABLE 1

| | | | | | |
|---|---|---|---|---|---|
| | | | Uploading | | |
| | | | additional | | |
| | | | information | | |
| | Synthesizing | Uploading | of the | Creating the | |
| Requesting | multimedia | multimedia | multimedia | multimedia | Completing |
| parameters | resources | content item | content item | content item | the posting |

| iOS | Running in the background | Running in the background supported. |
|---|---|---|
| | not supported. | |

| | |
|---|---|
| Android | Running in the background supported. |

Some applications allow the user to post a plurality of pieces of multimedia content item repeatedly or simultaneously to improve overall efficiency of multimedia content item posting. For example, the user may first trigger the posting of first multimedia content item, and before the posting of the first multimedia content item is completed, exit a posting interface of the first multimedia content item and then trigger the posting of second multimedia content item, and so on. For another example, the user may simultaneously trigger the posting of a plurality of pieces of multimedia content item. However, the user may want to use other functions in the terminal before the posting of a plurality of pieces of multimedia content item is completed. Then, the user may switch the application to the background, for example, by displaying the operating system desktop of the terminal. In this case, if the posting of a specific piece of multimedia content item is interrupted or completed, it is difficult for the user to perform a subsequent operation in a timely manner, reducing multimedia content item posting efficiency.

Therefore, the present disclosure provides a multimedia content item posting method, a related device, and a computer-readable storage medium, to at least improve multimedia content item posting efficiency and improve user experience.

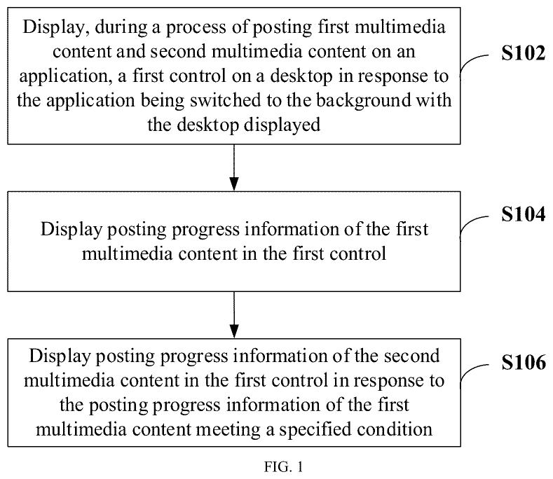

According to the present disclosure, after the application is switched to the background, a first control on a desktop is used to display posting progress information of the first multimedia content item or the second multimedia content item, so that the user understands posting progress of the multimedia content item in a timely manner. Embodiments of the multimedia content item posting method according to the present disclosure are described below with reference to FIG. 1. The method may be performed by an electronic device. The electronic device may be a tablet computer, a mobile phone (such as a foldable phone and a large-screen phone), a wearable device, a vehicle-mounted device, an augmented reality (AR)/virtual reality (VR) device, a notebook computer, an ultra-mobile personal computer (UMPC), a netbook, a personal digital assistant (PDA), a smart TV, a smart screen, a high-definition television, a 4K television, a smart speaker, a smart projector or other Internet of Things (IoT) devices. The present disclosure does not impose any limitation on the specific type of the electronic device.

FIG. 1 is a schematic flowchart of a multimedia content item posting method according to some embodiments of the present disclosure. As shown in FIG. 1, the posting method in this embodiment includes steps S102 to S106.

In step S102, during a process of posting first multimedia content item and second multimedia content item on an application, a first control is displayed on a desktop in response to the application being switched to the background with the desktop displayed.

The application is an application in an electronic device, and may run on an operating system of the electronic device. The application may be any type of application that features posting of multimedia content item, such as a video application, a social application, and an educational application.

The multimedia content item includes, for example, types such as videos, audio, and graphic content. The first multimedia content item and the second multimedia content item may be of any types, and may be of the same or different types. The user triggers the posting of the first multimedia content item and the second multimedia content item in the application, for example, by triggering a function such as “Post the creation” in the application, so that the posting process of the first multimedia content item and the second multimedia content item can be started. The process of posting the first multimedia content item and the second multimedia content item on the application is a process after the posting of the first multimedia content item and the second multimedia content item is started and before the posting is completed.

The desktop may be a desktop of the electronic device (or referred to as the terminal), or a desktop of the operating system of the electronic device. The first control may be a control of the operating system, which is not a specific application binding, but can receive and display data transmitted by the application. The first control may be displayed only on the desktop, or may float on an upper layer of another application when the another application is displayed. In other words, the first control is a global component in the electronic device. Taking iOS as an example, the first control may be “Dynamic Island”.

In step S104, posting progress information of the first multimedia content item is displayed in the first control.

The posting progress information is used to indicate the progress or status of the posting process of multimedia content item. The posting progress information is, for example, a name or description information of a current posting stage of the multimedia content item, such as “First stage”, “Stage B”, “Uploading”, and “Creating”, so that the user can clearly know the current posting stage. In some embodiments, based on a posting stage of the first multimedia content item or the second multimedia content item, description information of the posting stage is displayed.

The posting progress information may alternatively be a posting progress value, which may be displayed by a number or a progress bar to indicate a completion degree of the posting process, so as to ensure that a display interface is more intuitive and concise. For posting progress values corresponding to various stages, refer to Table 2, for example. In Table 2, for example, a numerical value 100 is used to indicate a corresponding progress value when the posting is completed, that is, a numerical value corresponding to the entire posting process. Therefore, other progress values may be easily converted to denote a percentage of a current completed process in the entire posting process when the process is performed to a current stage. For example, when the process is performed to the stage of “Uploading multimedia content item”, the entire posting process has reached 61% to 97%. It should be clear to those skilled in the art that Table 2 is only an exemplary representation, and the numerical values therein are also exemplary, without any restrictions on the solutions of the present disclosure.

TABLE 2

| | | | | Uploading | | |
|---|---|---|---|---|---|---|
| | | | | additional | | |
| | | | | information | | |
| | | Synthesizing | Uploading | of the | Creating the | |
| | Requesting | multimedia | multimedia | multimedia | multimedia | Completing |
| | parameters | resources | content item | content item | content item | the posting |
| Progress | 0-1 | 1-60 | 61-97 | 98 | 99 | 100 |
| value | | | | | | |

Since progress values corresponding to some posting stages each are a numerical range, a specific posting progress value may be further determined with reference to duration of the current posting stage of the multimedia content item. To be specific, in some embodiments, a posting progress value is displayed based on a posting stage of the first multimedia content item or the second multimedia content item and duration of the posting stage. For example, when the first multimedia content item is just switched from the stage of synthesizing a multimedia resource to the stage of uploading multimedia content item, in the stage of uploading multimedia content item, an initial posting progress value may be 61. With the progress of uploading, that is, as the time during which the first multimedia content item is in the stage of “Uploading multimedia content item” increases, the posting progress value gradually increases. A growth rate of the posting progress value may be determined based on an increase amount of the progress value corresponding to a preset unit time, or based on a ratio of duration of a current posting stage of the first multimedia content item to estimated total duration of the posting stage. The estimated total duration may be determined based on a quantity of resources involved in the multimedia content item. Therefore, the current posting progress can be reflected more accurately.

When the posting process of the multimedia content item cannot continue, a posting interruption prompt of the multimedia content item is displayed. In some embodiments, a posting interruption prompt of the first multimedia content item is displayed in response to a posting stage of the first multimedia content item being not allowed to run in the background. The posting interruption prompt may be a descriptive text or a symbol. For example, by an exclamation mark (!), a wrong sign (x), an expression expressing frustration, or “posting paused, please return to the application to resume”, the user is prompted that there is a problem in the current posting process. Therefore, the user can return to the application in a timely manner to check, so as to solve the problem of posting interruption. For example, if the posting is interrupted because the current stage is not allowed to run in the background, the user may resume the posting process by returning to the application, that is, switching the application to the foreground.

In some embodiments, posting progress information of multimedia content item includes a posting interruption prompt, and in response to a first operation on the first control, the application is displayed and the posting process of the multimedia content item is resumed. Therefore, the user can return to the application in a timely manner by using the first control when learning, by using the first control, that the current posting process is interrupted. The first operation may be a trigger operation, or another operation that is set as required.

In some embodiments, posting progress information of multimedia content item includes at least one of a cover of the first multimedia content item or an identifier of the application. By displaying of the cover of the multimedia content item, it can be indicated whether the currently displayed posting progress information is for the first multimedia content item or the second multimedia content item. By displaying of the identifier of the application, a specific application that the current information is aimed at can be indicated. However, in the case of limited display space or in some other circumstances, the cover of the multimedia content item or the identifier of the application may not be displayed, provided that it is indicated only by the posting progress information that there is currently multimedia content item in the posting process.

In step S106, posting progress information of the second multimedia content item is displayed in the first control in response to the posting progress information of the first multimedia content item meeting a specified condition.

The specified condition is, for example, that the posting of the first multimedia content item is completed (that is, the posting progress information indicates that the posting is completed, or indicates that the posting stage is completed). In this case, it is not necessary to continue displaying the posting progress information of the first multimedia content item, so the posting progress information of the second multimedia content item may be displayed instead. Therefore, in this case, information that the user is more concerned about may be displayed preferentially.

The specified condition may alternatively be that display duration of the posting progress information of the first multimedia content item reaches specified duration, so that posting progress information of different multimedia content item can be switched and displayed for the user at a time interval, and thus the user can fully understand a posting status of a plurality of pieces of multimedia content item. In some embodiments, after display duration of the posting progress information of the second multimedia content item reaches specified duration, the posting progress information of the first multimedia content item or third multimedia content item may alternatively be displayed again, so as to implement alternate display of the two.

In some embodiments, the above two methods may alternatively be used in combination. For example, a plurality of pieces of multimedia content item in the posting process are alternately displayed. After posting of a specific piece of multimedia content item is completed, posting progress information of multimedia content item other than the multimedia content item is alternately displayed. If only one piece of multimedia content item whose posting is not completed remains, only posting progress information of the remaining multimedia content item is displayed.

In some embodiments, in response to the posting progress information of the first multimedia content item meeting a specified condition, switching from the posting progress information of the first multimedia content item to the posting progress information of the second multimedia content item is performed in the first control. In other words, the posting progress information of the first multimedia content item is no longer displayed, and the posting progress information of the second multimedia content item is displayed instead.

For the specific implementation of displaying the posting progress information of the second multimedia content item, reference may be made to the related description of the posting progress information of the first multimedia content item after step S104. In other words, based on a posting stage of the second multimedia content item, a name or description information of the posting stage may be displayed; and a posting progress value is displayed based on a posting stage of the second multimedia content item and duration of the posting stage, or a posting interruption prompt of the second multimedia content item is displayed in response to a posting stage of the second multimedia content item being not allowed to run in the background. Other details are not described herein.

Similar to that of the first multimedia content item, in some embodiments, the posting progress information of the second multimedia content item includes a posting interruption prompt, and in response to a first operation on the first control, the application is displayed and the posting process of the second multimedia content item is resumed. Therefore, the user can return to the application in a timely manner by using the first control when learning, by using the first control, that the current posting process is interrupted.

Based on the above embodiment, when posting of a plurality of pieces of multimedia content item is not completed, the posting progress of the multimedia content item can be reflected to the user in a timely manner by using the desktop control, so that the user can perform a subsequent operation in a timely manner based on a posting status of the multimedia content item, thereby improving multimedia content item posting efficiency and improving user experience.

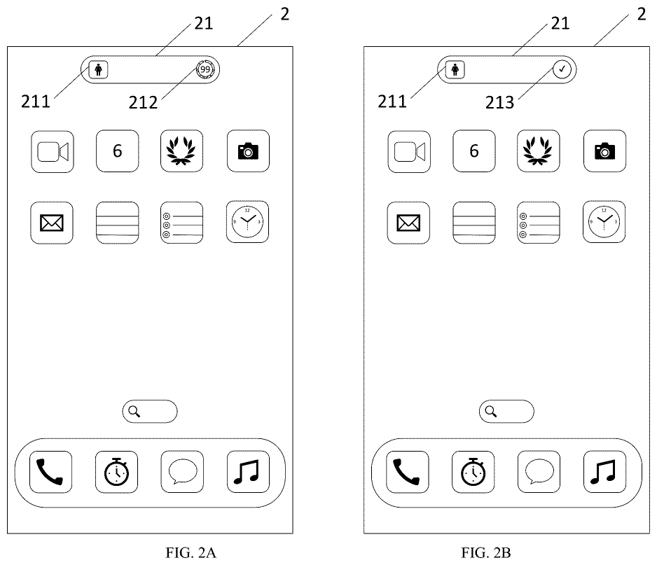

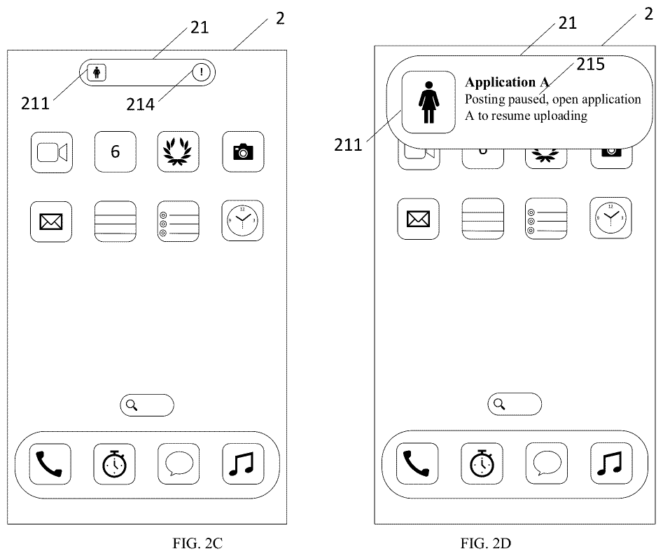

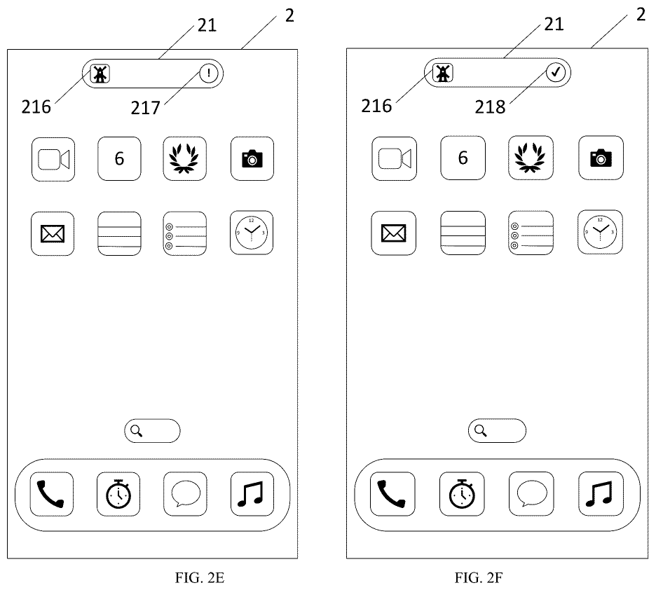

FIG. 2A, FIG. 2B, and FIG. 2C are schematic diagrams of a first control according to some embodiments of the present disclosure. As shown in FIG. 2A, FIG. 2B, and FIG. 2C, a desktop 2 includes some application icons and a first control 21, and the first control 21 displays posting progress information of multimedia content item. For example, a cover 211 of the multimedia content item (for example, a video) is displayed in the first control 21. The posting progress information in FIG. 2A is represented by, for example, a progress value 212, indicating that the first multimedia content item is in the posting process. The posting progress information in FIG. 2B is represented by, for example, a check mark 213, indicating that the posting of the first multimedia content item is completed. The posting progress information in FIG. 2C is represented by, for example, an exclamation mark 214, indicating that the posting of the first multimedia content item is interrupted.

In some embodiments, a display area of the first control is expanded in response to a second operation on the first control to display more detailed posting progress information. The second operation is, for example, a touch and hold operation, or another operation that is set as required. Therefore, before the second operation is performed on the first control, the posting progress information is displayed in an abbreviated manner to save display space, and after the second operation is performed, more detailed posting progress information is displayed so that the user gets a clearer understanding. For example, before the second operation is performed on the first control, a posting progress value or a posting interruption prompt of the first multimedia content item or the second multimedia content item is displayed in the first control. The display area of the first control is expanded in response to the second operation on the first control, and description information of a posting stage of the first multimedia content item or the second multimedia content item is displayed in the expanded first control.

Taking posting interruption in FIG. 2C as an example, an interface shown in FIG. 2D is displayed in response to the second operation on the first control 21. In FIG. 2D, the display area of the first control 21 is larger, and description information 215, for example, “Posting paused, open application A to resume uploading”, is displayed instead of a relatively abbreviated form in FIG. 2C. In addition, “Application A” may be also displayed to indicate that this is a prompt from the application A.

The above FIG. 2A to FIG. 2D are applicable to the first multimedia content item and the second multimedia content item.

A posting method in an application scenario is described again below, for example.

It is assumed that a posting process include a first posting stage and a second posting stage, and each of the first posting stage and the second posting stage may further include one or more posting stages (for example, reference is made to the description in the aforementioned embodiment). The first posting stage is not allowed to run in the background, and the second posting stage is allowed to run in the background. For example, in the iOS, requesting a parameter and synthesizing a multimedia resource may be in the first posting stage, and uploading multimedia content item, uploading additional information of the multimedia content item, creating multimedia content item, and completing posting may be in the second posting stage. In this case, the following scenario may exist.

After the user triggers a posting process in a posting interface of the first multimedia content item, an application first executes the first posting stage for the first multimedia content item. Since the first posting stage is not allowed to run in the background, the user waits at the current page. When execution of the first posting stage is completed and the second posting stage is reached, the user may exit the current posting interface, and the posting process of the first multimedia content item continues to be executed in the background. In this case, the user further creates or uploads second multimedia content item, triggers a posting process of the second multimedia content item, and then switches to a desktop. In this case, after the user switches to the desktop, that is, after the application runs in the background, if posting of the first multimedia content item is not completed, the first multimedia content item is in the second posting stage, and the second multimedia content item is in the first posting stage.

In view of the above scenario, in some embodiments, the first control first displays posting progress information of the first multimedia content item, and for example, as shown in FIG. 2A, displays a specific posting progress value 212. With the passage of time, the posting of the first multimedia content item is completed. In this case, as shown in FIG. 2B, an identifier 213 indicating completion of the posting may be displayed. Then, the first control stops displaying the posting progress information of the first multimedia content item, but displays posting progress information of the second multimedia content item. Since the second multimedia content item is in a stage that is not allowed to run in the background, an interface shown in FIG. 2E is displayed, that is, a prompt 217 that the posting of the second multimedia content item is interrupted is displayed in the first control 21. Therefore, a current posting status of the first multimedia content item can be updated in real time in the process of promoting the posting of the first multimedia content item. When the posting of the second multimedia content item is interrupted, the user is informed in a timely manner so that the user returns to the application to trigger the uploading of the second multimedia content item to be resumed. It should be noted that it is assumed that in this embodiment, the cover 211 in FIG. 2A and FIG. 2B is a cover of the first multimedia content item, and a cover 216 in FIG. 2E is a cover of the second multimedia content item. Certainly, the first control 21 may alternatively include no cover, but instead use other information such as a name of multimedia content item and an identifier of an application, or display no such cover or identifier information.

In some embodiments, a start time of the posting process of the first multimedia content item is not later than a start time of the posting process of the second multimedia content item. In other words, the user first triggers the posting of the first multimedia content item, or triggers the posting of the two pieces of multimedia content item at the same time. After the posting of the first multimedia content item and the second multimedia content item is completed (that is, the posting is completed in the background), a playback interface of the posted second multimedia content item is displayed in the application in response to the application being switched to the foreground. To be specific, after posting of a plurality of pieces of multimedia content item is completed in the background, in response to the user switching back to the foreground again, a posting result of post-triggered multimedia content item may be first displayed, so as to visually inform the user that posting of two pieces of multimedia content item is completed.

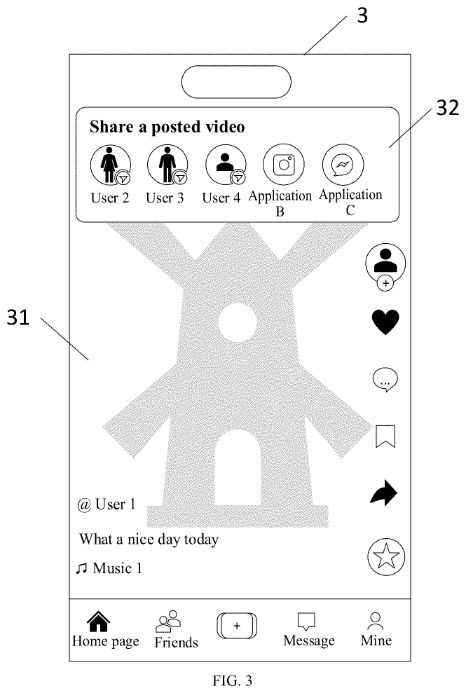

For example, reference is still made to the aforementioned embodiment of FIG. 2E, after triggering the first control 21, the user may return to the application to resume the posting process of the second multimedia content item. When the second multimedia content item enters the second posting stage, the user may switch the application to the background again as required. After the posting of the second multimedia content item is completed, an interface of the second multimedia content item may be shown in FIG. 2F, and a check mark 218 indicates that the posting of the second multimedia content item is completed. In this case, the user may return to the application by triggering the first control 21 or by other means, and the returned application interface may be shown in FIG. 3.

FIG. 3 is a schematic diagram of a multimedia content item playback interface according to some embodiments of the present disclosure. As shown in FIG. 3, in the interface 3, second multimedia content item 31 is displayed and played, and a second control 32 is displayed. The second control 32 includes identifiers of a plurality of sharing channels to share to users 2, 3, 4, and the like, or to share via applications B, C, and the like. Details are not described herein.

The embodiments of the multimedia content item posting method according to the present disclosure are described above, for example. A related apparatus, device, and system according to the present disclosure are further described below with reference to FIG. 4 to FIG. 6.

FIG. 4 is a schematic diagram of a structure of a multimedia content item posting apparatus according to some embodiments of the present disclosure. As shown in FIG. 4, a posting apparatus 40 in this embodiment includes: a first display module 410, configured to display, during a process of posting first multimedia content item and second multimedia content item on an application, a first control on a desktop in response to the application being switched to the background with the desktop displayed; a second display module 420, configured to display posting progress information of the first multimedia content item in the first control; and a third display module 430, configured to display posting progress information of the second multimedia content item in the first control in response to the posting progress information of the first multimedia content item meeting a specified condition.

In some embodiments, the third display module 430 is further configured to display the posting progress information of the second multimedia content item in response to completion of the posting of the first multimedia content item.

In some embodiments, the posting progress information of the second multimedia content item includes a posting interruption prompt, and the posting apparatus 40 further includes: a fourth display module, configured to display the application and resume the posting process of the second multimedia content item in response to a first operation on the first control.

In some embodiments, after the application is switched to the background, the second multimedia content item is in a first posting stage, the first multimedia content item is in a second posting stage, the first posting stage is not allowed to run in the background, and the second posting stage is allowed to run in the background.

In some embodiments, a start time of the posting process of the first multimedia content item is not later than a start time of the posting process of the second multimedia content item.

In some embodiments, the posting apparatus 40 further includes: a fifth display module, configured to display, after the posting of the first multimedia content item and the second multimedia content item is completed, a playback interface of the posted second multimedia content item in the application in response to the application being switched to the foreground.

In some embodiments, the third display module 430 is further configured to display the posting progress information of the second multimedia content item in response to display duration of the posting progress information of the first multimedia content item reaching specified duration.

In some embodiments, the second display module 420 is further configured to display, based on a posting stage of the first multimedia content item, a name or description information of the posting stage; and display a posting progress value based on a posting stage of the first multimedia content item and duration of the posting stage.

In some embodiments, the third display module 430 is further configured to display, based on a posting stage of the second multimedia content item, a name or description information of the posting stage; and display a posting progress value based on a posting stage of the second multimedia content item and duration of the posting stage.

In some embodiments, the second display module 420 is further configured to display a posting interruption prompt of the first multimedia content item in response to a posting stage of the first multimedia content item being not allowed to run in the background.

In some embodiments, the third display module 430 is further configured to display a posting interruption prompt of the second multimedia content item in response to a posting stage of the second multimedia content item being not allowed to run in the background.

In some embodiments, the second display module 420 is further configured to display a posting progress value or a posting interruption prompt of the first multimedia content item in the first control; and expand a display area of the first control, and display description information of a posting stage of the first multimedia content item in the expanded first control, in response to a second operation on the first control.

In some embodiments, the third display module 430 is further configured to display a posting progress value or a posting interruption prompt of the second multimedia content item in the first control; and expand a display area of the first control, and display description information of a posting stage of the second multimedia content item in the expanded first control, in response to a second operation on the first control.

In some embodiments, the posting progress information of either of the first multimedia content item and the second multimedia content item includes at least one of a cover of the first multimedia content item or the second multimedia content item or an identifier of the application.

In some embodiments, the posting process of the first multimedia content item and the second multimedia content item includes one or more stages of requesting parameters, synthesizing multimedia resources, uploading multimedia content item, uploading additional information of the multimedia content item, creating the multimedia content item, and completing the posting; the requesting parameters and the synthesizing multimedia resources are not allowed to run in the background; and the uploading multimedia content item, the uploading additional information of the multimedia content item, the creating the multimedia content item, and the completing the posting are allowed to run in the background.

It should be noted that the above-mentioned various units are merely logical modules divided according to specific functions implemented by the units, and are not used to limit specific implementations. For example, the units may be implemented by software, hardware, or a combination of software and hardware. In actual implementation, the above-mentioned various units may be implemented as separate physical entities, or may be implemented by a single entity (for example, a processor (a CPU, a DSP, etc.), or an integrated circuit). In addition, the above-mentioned various units are shown with dotted lines in the accompanying drawings to indicate that these units may not actually exist, and the operations/functions implemented thereby may be implemented by a processing circuit.

In addition, although not shown, the device may further include a memory, which may store various information generated during the operations by the device and the various units included in the device, programs and data used for the operations, data to be sent by a communication unit, etc. The memory may be a volatile memory and/or a non-volatile memory. For example, the memory may include, but is not limited to, a random access memory (RAM), a dynamic random access memory (DRAM), a static random access memory (SRAM), a read-only memory (ROM), and a flash memory. Certainly, the memory may alternatively be located outside the device. Optionally, although not shown, the device may further include a communication unit, which may be configured to communicate with other apparatuses. In an example, the communication unit may be implemented in an appropriate manner known in the art, for example, including communication components such as an antenna array and/or a radio frequency link, various types of interfaces, communication units, and the like. This is not described in detail herein. In addition, the device may further include other components not shown, such as a radio frequency link, a baseband processing unit, a network interface, a processor, and a controller. This is not described in detail herein.

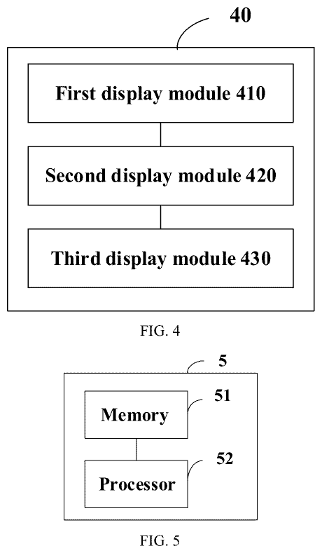

Some embodiments of the present disclosure further provide an electronic device. FIG. 5 is a schematic diagram of a structure of an electronic device according to some embodiments of the present disclosure. For example, in some embodiments, the electronic device 5 may be various types of devices, for example, may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. For example, the electronic device 5 may include a display panel configured to display data and/or execution results used in the solution according to the present disclosure. For example, the display panel may be in various shapes, such as a rectangular panel, an elliptical panel, or a polygonal panel. In addition, the display panel may be a flat panel, a curved panel, or even a spherical panel.

As shown in FIG. 5, the electronic device 5 in this embodiment includes: a memory 51 and a processor 52 coupled to the memory 51. It should be noted that the components of the electronic device 5 shown in FIG. 5 are merely exemplary and non-limiting. The electronic device 5 may further have other components according to actual application requirements. The processor 52 may control other components in the electronic device 5 to perform desired functions.

In some embodiments, the memory 51 is configured to store one or more computer-readable instructions. The processor 52 is configured to run computer-readable instructions, and the computer-readable instructions, when running by the processor 52, cause the method according to any one of the above embodiments to be implemented. For specific implementations of the steps of the method and related explanation contents, reference may be made to the above embodiments, and repetitions are not repeated herein.

For example, the processor 52 and the memory 51 may directly or indirectly communicate with each other. For example, the processor 52 and the memory 51 may communicate over a network. The network may include a wireless network, a wired network, and/or any combination of a wireless network and a wired network. The processor 52 and the memory 51 may also communicate with each other by a system bus. This is not limited in the present disclosure.

For example, the processor 52 may be embodied as various appropriate processors, processing apparatuses, etc., such as a central processing unit (CPU), a graphics processing unit (GPU), and a network processor (NP); or may be a digital signal processor (DSP), an application-specific integrated circuit (ASIC), a field programmable gate array (FPGA) or other programmable logic devices, a discrete gate or transistor logic device, or a discrete hardware component. The central processing unit (CPU) may have an X86 or ARM architecture or the like. For example, the memory 51 may include any combination of various forms of computer-readable storage media, for example, a volatile memory and/or a non-volatile memory. The memory 51 may include, for example, a system memory, and the system memory stores, for example, an operating system, an application, a boot loader, a database, and other programs. Various applications, various data, and the like may further be stored in the storage medium.

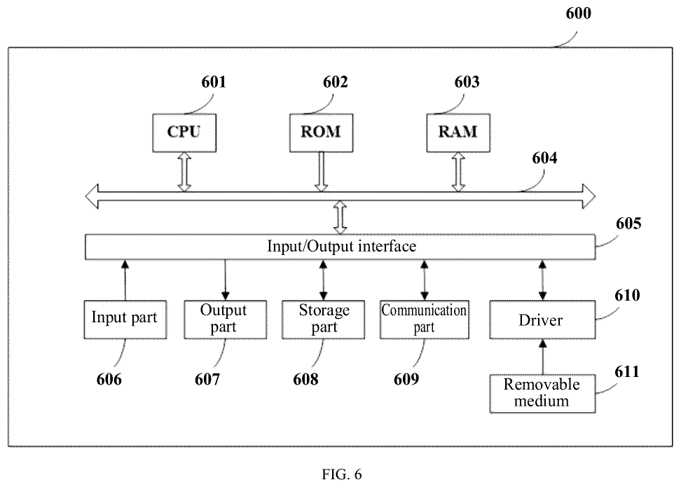

In addition, according to some embodiments of the present disclosure, when various operations/processing according to the present disclosure are implemented by software and/or firmware, programs constituting the software may be installed from the storage medium or a network to a computer system with a dedicated hardware structure, such as a computer system 60 shown in FIG. 6. When installed with various programs, the computer system can perform various functions, including the functions described above, etc. FIG. 6 is a schematic diagram of a structure of a computer system according to some embodiments of the present disclosure.

In FIG. 6, a central processing unit (CPU) 601 performs various processing according to a program stored in a read-only memory (ROM) 602 or loaded from a storage part 608 into a random access memory (RAM) 603. Data required for the CPU 601 to perform various processing and the like is also stored in the RAM 603 as required. The central processing unit is merely exemplary, and it may alternatively be other types of processors, such as the various processors described above. The ROM 602, the RAM 603, and the storage part 608 may be various forms of computer-readable storage media, as described below. It should be noted that although the ROM 602, the RAM 603, and the storage apparatus 608 are shown separately in FIG. 6, one or more of them may be combined or located in the same or different memories or storage modules.

The CPU 601, the ROM 602, and the RAM 603 are connected to one another through a bus 604. An input/output interface 605 is also connected to the bus 604.

The following components are connected to the input/output interface 605: an input part 606, for example, a touch screen, a touchpad, a keyboard, a mouse, an image sensor, a microphone, an accelerometer, or a gyroscope; an output part 607, including a display, such as a cathode-ray tube (CRT), a liquid crystal display (LCD), a speaker, or a vibrator; the storage part 608, including a hard disk, a magnetic tape, etc.; and a communication part 609, including a network interface card, such as a LAN card, or a modem. The communication part 609 allows communication processing to be performed over a network such as the Internet. It is easy to understand that although the various apparatuses or modules in the computer system 60 shown in FIG. 6 communicate by the bus 604, they may alternatively communicate over a network or by other means, where the network may include a wireless network, a wired network, and/or any combination of wireless networks and wired networks.

A driver 610 is also connected to the input/output interface 605 as required. A removable medium 611 such as a magnetic disk, an optical disc, a magneto-optical disc, or a semiconductor memory, is installed on the driver 610 as required, such that a computer program read therefrom is installed into the storage part 608 as required.

When the above-described series of processing is implemented by software, programs constituting the software may be installed from a network such as the Internet or a storage medium such as the removable medium 611.

According to an embodiment of the present disclosure, the process described above with reference to the flowcharts may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded from a network through the communication apparatus 609 and installed, installed from the storage apparatus 608, or installed from the ROM 602. When the computer program is executed by the CPU 601, the above-mentioned functions defined in the method of the embodiments of the present disclosure are performed.

It should be noted that in the context of the present disclosure, a computer-readable medium may be a tangible medium that may contain or store a program used by or in combination with an instruction execution system, apparatus, or device. The computer-readable medium may be a computer-readable signal medium, a computer-readable storage medium, or any combination thereof. Examples of the computer-readable storage medium may include, but are not limited to: electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

The above computer-readable medium may be contained in the above electronic device. Alternatively, the computer-readable medium may exist independently, without being assembled into the electronic device.

In some embodiments, there is further provided a computer program including instructions that, when executed by a processor, cause the processor to perform the method according to any one of the foregoing embodiments. For example, the instructions may be embodied as computer program code.

In the embodiments of the present disclosure, the computer program code for performing the operations of the present disclosure may be written in one or more programming languages or a combination thereof, where the programming languages include, but are not limited to, an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In a case involving the remote computer, the remote computer may be connected to the computer of the user over any kind of network (including a local area network (LAN) or a wide area network (WAN)), or may be connected to an external computer (for example, connected over the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related modules, components, or units described in the embodiments of the present disclosure may be implemented by software, or may be implemented by hardware. The names of the modules, components, or units do not constitute a limitation on the modules, components, or units themselves in some cases.

The functions described herein above may be performed at least partially by one or more hardware logic components. For example, without limitation, exemplary hardware logic components that may be used include: a field programmable gate array (FPGA), an application-specific integrated circuit (ASIC), an application-specific standard product (ASSP), a system-on-chip (SOC), a complex programmable logic device (CPLD), and the like.

The foregoing descriptions are merely some embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In the description provided herein, numerous specific details are set forth. However, it is understood that the embodiments of the present invention may be practiced without these specific details. In other cases, well-known methods, structures, and techniques have not been shown in detail in order not to obscure the understanding of this description.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

While some specific embodiments of the present disclosure have been exemplarily described in detail, it should be understood by those skilled in the art that the above examples are merely for illustration and are not intended to limit the scope of the present disclosure. Those skilled in the art should understand that various modifications can be made to the above embodiments, without departing from the scope and spirit of the present disclosure. The scope of the present disclosure is defined by the appended claims.

What is claimed is:

1. A posting method of multimedia content item, comprising:
displaying, during a process of posting a first multimedia content item and a second multimedia content item through an application, a first control on a desktop in response to the application being switched to run in background with the desktop displayed;
displaying posting progress information of the first multimedia content item in the first control; and
displaying posting progress information of the second multimedia content item in the first control in response to the posting progress information of the first multimedia content item meeting a specified condition.

2. The posting method according to claim 1, wherein the displaying the posting progress information of the second multimedia content item in response to the posting progress information of the first multimedia content item meeting the specified condition comprises:
displaying the posting progress information of the second multimedia content item in response to completion of the posting of the first multimedia content item.

3. The posting method according to claim 1, wherein the posting progress information of the second multimedia content item comprises a posting interruption prompt, and the posting method further comprises:
displaying the application and resuming the process of posting the second multimedia content item in response to a first operation on the first control.

4. The posting method according to claim 2, wherein after the application is switched to run in background, the second multimedia content item is in a first posting stage, the first multimedia content item is in a second posting stage, the first posting stage is not allowed to run in background, and the second posting stage is allowed to run in background.

5. The posting method according to claim 1, wherein a start time of the progress of posting the first multimedia content item is not later than a start time of the progress of posting the second multimedia content item.

6. The posting method according to claim 5, further comprising:
displaying, after the posting of the first multimedia content item and the second multimedia content item is completed, a playback interface of the posted second multimedia content item in the application in response to the application being switched to run in foreground.

7. The posting method according to claim 1, wherein displaying the posting progress information of the second multimedia content item in response to the posting progress information of the first multimedia content item meeting the specified condition comprises:
displaying the posting progress information of the second multimedia content item in response to display duration of the posting progress information of the first multimedia content item reaching specified duration.

8. The posting method according to claim 1, wherein for the posting progress information of either of the first multimedia content item or the second multimedia content item, displaying the posting progress information comprises at least one of:
displaying, based on a posting stage of the first multimedia content item or the second multimedia content item, a name or description information of the posting stage; or
displaying a posting progress value based on the posting stage and duration of being in the posting stage of the first multimedia content item or the second multimedia content item.

9. The posting method according to claim 1, wherein for the posting progress information of either of the first multimedia content item or the second multimedia content item, displaying the posting progress information comprises:
displaying a posting interruption prompt of the first multimedia content item or the second multimedia content item in response to a posting stage of the first multimedia content item or the second multimedia content item being not allowed to run in background.

10. The posting method according to claim 1, wherein for the posting progress information of either of the first multimedia content item or the second multimedia content item, displaying the posting progress information comprises:
displaying a posting progress value or a posting interruption prompt of the first multimedia content item or the second multimedia content item in the first control; and
expanding a display area of the first control and displaying description information of a posting stage of the first multimedia content item or the second multimedia content item in the expanded first control in response to a second operation on the first control.

11. The posting method according to claim 1, wherein
the posting progress information of either of the first multimedia content item or the second multimedia content item comprises at least one of a cover of the first multimedia content item or the second multimedia content item or an identifier of the application.

12. The posting method according to claim 1, wherein the process of posting the first multimedia content item and the second multimedia content item comprises one or more stages of requesting parameters, synthesizing multimedia resources, uploading multimedia content item, uploading additional information of the multimedia content item, creating the multimedia content item, and completing the posting; the requesting parameters and the synthesizing multimedia resources are not allowed to run in background; and the uploading multimedia content item, the uploading additional information of the multimedia content item, the creating the multimedia content item, and the completing the posting are allowed to run in background.

13. An electronic device, comprising:
a memory; and
a processor coupled to the memory, wherein the processor is configured to, based on instructions stored in the memory, perform a posting method of multimedia content item comprising:
displaying, during a process of posting a first multimedia content item and a second multimedia content item through an application, a first control on a desktop in response to the application being switched to run in background with the desktop displayed;
displaying posting progress information of the first multimedia content item in the first control; and
displaying posting progress information of the second multimedia content item in the first control in response to the posting progress information of the first multimedia content item meeting a specified condition.

14. The electronic device according to claim 13, wherein the displaying the posting progress information of the second multimedia content item in response to the posting progress information of the first multimedia content item meeting the specified condition comprises:
displaying the posting progress information of the second multimedia content item in response to completion of the posting of the first multimedia content item.

15. The electronic device according to claim 13, wherein the posting progress information of the second multimedia content item comprises a posting interruption prompt, and the posting method further comprises:
displaying the application and resuming the process of posting the second multimedia content item in response to a first operation on the first control.

16. The electronic device according to claim 14, wherein after the application is switched to run in background, the second multimedia content item is in a first posting stage, the first multimedia content item is in a second posting stage, the first posting stage is not allowed to run in background, and the second posting stage is allowed to run in background.

17. The electronic device according to claim 13, wherein a start time of the progress of posting the first multimedia content item is not later than a start time of the progress of posting the second multimedia content item.

18. The electronic device according to claim 17, wherein the processor is further configured to:
display, after the posting of the first multimedia content item and the second multimedia content item is completed, a playback interface of the posted second multimedia content item in the application in response to the application being switched to run in foreground.

19. The electronic device according to claim 13, wherein displaying the posting progress information of the second multimedia content item in response to the posting progress information of the first multimedia content item meeting the specified condition comprises:
displaying the posting progress information of the second multimedia content item in response to display duration of the posting progress information of the first multimedia content item reaching specified duration.

20. A non-transitory computer-readable storage medium having a computer program stored thereon, wherein the program, when executed by a processor, causes the processor to implement a posting method of multimedia content item comprising:
displaying, during a process of posting a first multimedia content item and a second multimedia content item through an application, a first control on a desktop in response to the application being switched to run in background with the desktop displayed;
displaying posting progress information of the first multimedia content item in the first control; and
displaying posting progress information of the second multimedia content item in the first control in response to the posting progress information of the first multimedia content item meeting a specified condition.
